(19) United States
(12) Patent Application Publication
(10) Pub. No.: US 2007/0089535 A1
(43) Pub. Date: Apr. 26, 2007

(54) Digital torque control display

(76) Inventors: Chang-Ming Chen, Taichung County (TW); Yu-Ting Chen, Taichung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/247,927

(22) Filed: Oct. 10, 2005

(51) Int. Cl. B25B 23/14

(52) U.S. Cl. 73/862.22

(57) ABSTRACT

The present invention provides a digital torque control display that has external screw lines formed at the front end of the gun body and a torque adjuster is placed on it, and in the internal diameter of the torque adjuster has internal screw lines that can be used on the front end of the gun body; in addition, a through hole is placed in the center of the torque adjuster, and a rod is formed on both sides of the through hole, and the rod is connected to the first press, and one side of the first press is connected to a sensory displacement component, and the sensory displacement component is connected to a display, and the first press is connected to a spring, and the spring is different than one end of the first press that is connected to the second press, and the second press is driven by numbers of balls and an output axle, and one end of the output axle goes through the through hole, and a connecting hole is placed axially with a tool head; on the other end, it has clutch blade, and an input axle is placed correspondingly to the output axle, and the input axle that is corresponding to the output axle of the clutch blade also form a corresponding clutch blade.

### BACKGROUND OF INVENTION

1. Field of the Invention

The present invention relates generally to a technological field of digital torque control display, and more particularly to a tool that has display for the value calculated from the voltage differential generated from the displacement of the position of the sensory displacement component.

2. Description of Related Art

Electric gun and pneumatic gun have been used widely in the work place for tightening the screws, loosening the screws and drilling. Take tightening the screws for example, it can break the screw when too much torque is used, and it cannot tighten screw when the output torque is not enough; therefore, a good secure effect is achieved by controlling the output torque of the electric gun and pneumatic gun.

However, a conventional electric gun and pneumatic gun as shown in FIG. 5 achieves the function of torque control by the clutch; the output axle and input axle of the clutch can be locked in different ways; the upper edge of its gun body 30 has a torque scale 31. Also, the structure of the conventional structure shown in FIG. 6, and its coordination of the output axle 32 and input axle 33 of the clutch can be coordinated between the oblique surface 321 and ball 331. As shown in FIG. 6(a), when it is turning, the ball is locked in between the oblique surface 321, and when the torque exceeds the torque coordinated between the ball 331 and the oblique surface 321, the ball 331 passes the oblique surface 321, the output axle 32 and input axle skid, and the torque transmitted by the ball 331 and oblique surface 321 can be determined by the pressure from the frontal spring. There are also many methods for the gearing of the clutch, the coordination of the output axle 34 and input axle 35 can be oblique surface 341 and oblique surface 351 as shown in FIG. 6(b); or the coordination of the output axle 36 and the input axle 37 can be arc surface 361 and the arc surface 371 as shown in FIG. 6(c).

For this reason, the conventional electric gun and pneumatic gun shown in FIG. 7 has a torque adjuster 40 that has outer screw lines on the front end of the gun body 30, and the internal diameter of the torque adjuster 40 has internal screw lines that can be used on the front end of the gun body 30. A through hole 401 is placed in the center of the torque adjuster 40; a rod 402 shaped on both sides of the through hole 401, the rod 402 is connected to the first press 41; the first press 41 is driven by numbers of balls 42 and an output axle 43; one end of the output axle 43 go through the through hole 401; and a connecting hole 431 is placed axially with a tool head 50. On the other end, it has clutch blade 432, and an input axle 44 is placed correspondingly to the output axle 43; the input axle 43 that is corresponding to the output axle 43 of the clutch blade 432 also forms a corresponding clutch blade 441; the clutch blade 441 of the input axle 44 is driven by the numbers of balls 45 and a second press 46. In addition, there is a spring 47 that has one end connected to the second press 46; another end is connected to a stopper 48. Moreover, as shown in FIG. 5, the upper edge of the gun body 30 of the torque adjuster 40 has a torque scale 31.

By so doing, when the torque adjuster 4 is turning, its rod pushes against the first press 41, and the first press 41 pushes against the ball 42 and the clutch blade 432 of the output axle 43, and make the clutch blade 441 of the input axle 44 press against the ball 45 and the second press 46; the second press 46 presses the spring 47 to where the stopper 48 is. Therefore, the spring 47 presses against the second press 48, so that the clutch blade 432 441 of the output axle 43 and input axle 44 can gear to each other, and transmit the torque and spring press to form certain ratio relationship to achieve the controlling of the torque.

However, the conventional electric gun and pneumatic gun must turn the torque adjuster 40 to the torque scale 31 needed, and then, find the value of the torque by looking up the output torque scale 31.

Therefore, the conventional digital torque control display has the following disadvantages:

1) The error of the manufacturing and the actual torque creates error, such as the length of the spring 47, the diameter, outer diameter of the spring, the manufacturing error of the number of the rings, and the manufacturing error on the surface of the clutch, such as taper, connecting point, motor torque control and scale error.

2) Torque value with different unit needs to be converted, such as kg-cm, in-lb, N-m, and the torque value with different unit that cannot be converted to the whole number, such as in-lb, and the labeler who needs to use N-m cannot adjust it to the whole number, therefore, they must have electric gun and pneumatic gun that has different scales on it.

3) The scale of the electric gun and pneumatic gun can only label the torque scope roughly, and can only mark 10 or 20 scales, therefore, the precision obtained by using the scale to understand the torque value is obviously limited and cannot be used on the precise operation.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### SUMMARY OF THE INVENTION

The features and the advantages of the present invention will be more readily understood upon a thoughtful deliberation of the following detailed description of a preferred embodiment of the present invention with reference to the accompanying drawings.

The first objective of the present invention is to provide a digital torque control display, which displays the torque value digitally without reading error.

Moreover, the second objective of the present invention is to provide a digital torque control display, and its manufacturing error may be corrected by torque, and make the torque value very accurate.

However, another objective of the present invention is to provide a digital torque control display, which can switch the values of different unit by keying, and converted by the CPU calculation internally without any artificial conversion, and the value may be adjusted to the whole number after it is converted, which can be used on the torque gun with different unit.

So as to achieve the objective mentioned above, the present invention provides a digital torque control display, which is to for a outer screw lines on the front end of the gun, and place a torque adjuster, and the internal diameter of the torque adjuster has internal screw lines that can bed used on the front end of the gun body; moreover, a through hole is placed in the center of the torque adjuster, and a rod is formed on both sides of through hole, and the rod is connected to the first press, and the one side of the first press is connected to a sensory displacement component, and sensory displacement component connects to a display, and a spring is connected to the first press, and the spring is different than the first press that has one end connected to the second press, and the second press is driven by numbers of balls and an output axle, and one end of the output axle goes through the through hole, and a connecting hole is placed axially with a tool head, and on the other end, it has clutch blade, and an input axle is placed correspondingly to the output axle, and the input axle that is corresponding to the output axle of the clutch blade also form a corresponding clutch blade.

By so doing, when the torque adjuster is turning, its rod pushes the first press and makes the sensory displacement component of the first press create displacement, and the voltage differential generated by the displacement calculates the torque value by processing the signal, and display the value through the display.

Next one is a preferred embodiment, it can be used to further explain other objectives and effects of the present invention, and the features and the advantages of the present invention will be more readily understood upon a thoughtful deliberation of the following detailed description of a preferred embodiment of the present invention with reference to the accompanying drawings, however, it is not to limit the scope of the present invention; therefore, any invention that has the present invention as foundation and any modification of any form or shape of the creation of the present invention belongs in the scope the present invention desires to protect.

### BRIEF DESCRIPTION OF THE DRAWINGS

FIG. 1 shows the front perspective view of the before and after of the present invention before it is operated.

FIG. 2 shows the sectional perspective view of the present invention before it is operated.

FIG. 3 shows the official perspective view of the present invention after it is operated.

FIG. 4 shows the sectional view of the present invention after it is operated.

FIG. 5 shows the front perspective view of the conventional device before and after it is operated.

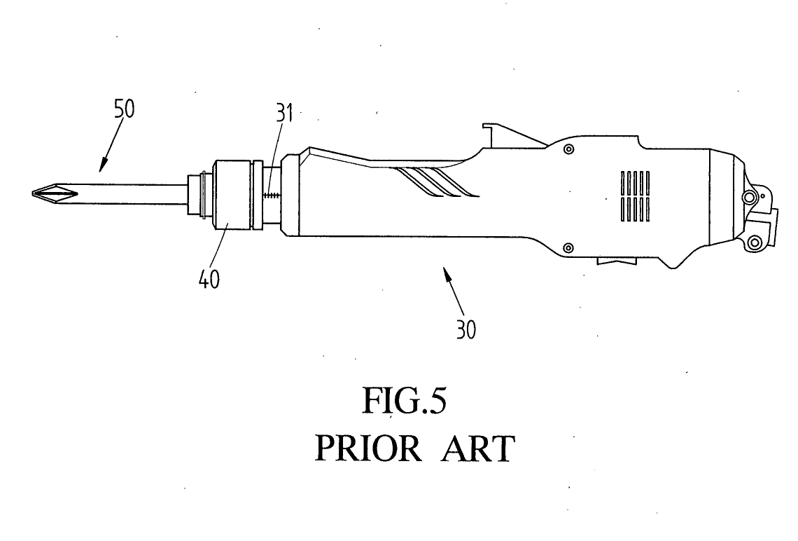

FIG. 6 shows the perspective view of the embodiment of the conventional clutch.

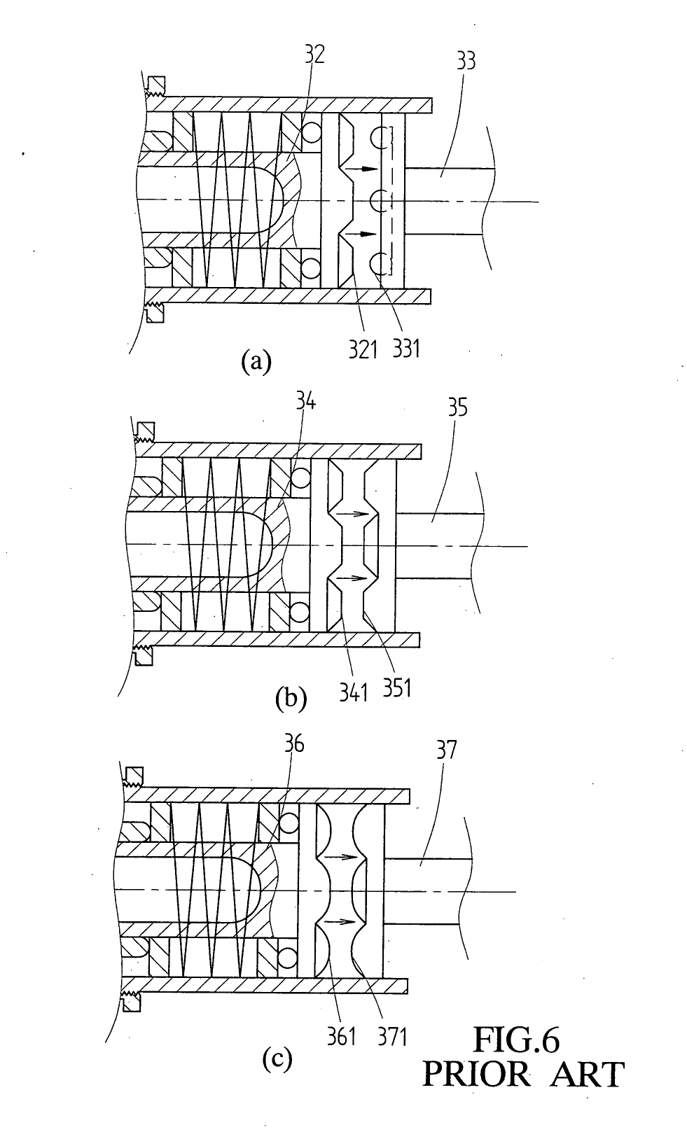

FIG. 7 shows the sectional perspective view of the conventional device before it is operated.

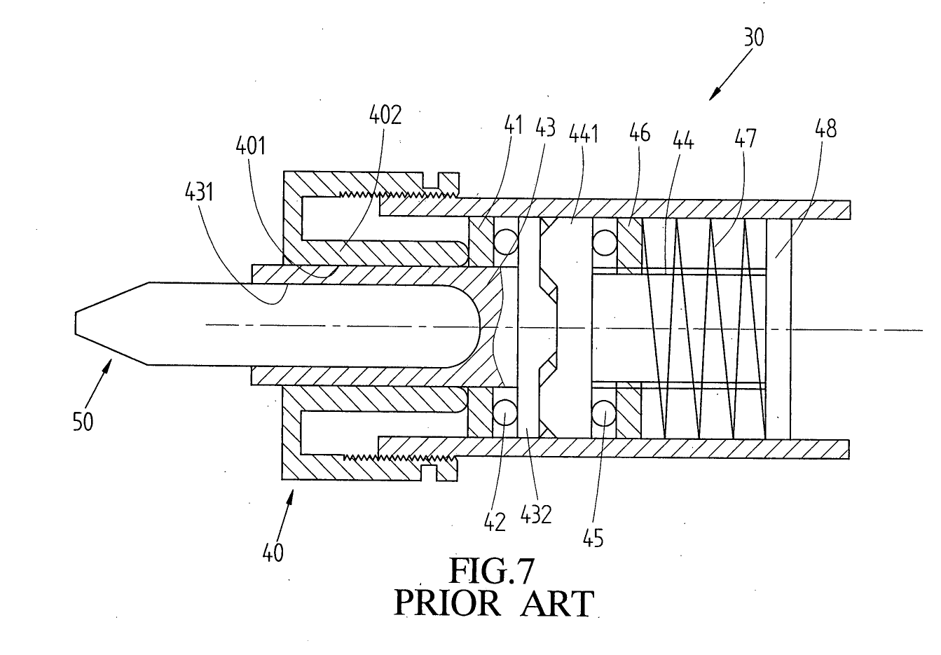

FIG. 8 shows the official perspective view of the conventional device after it is operated.

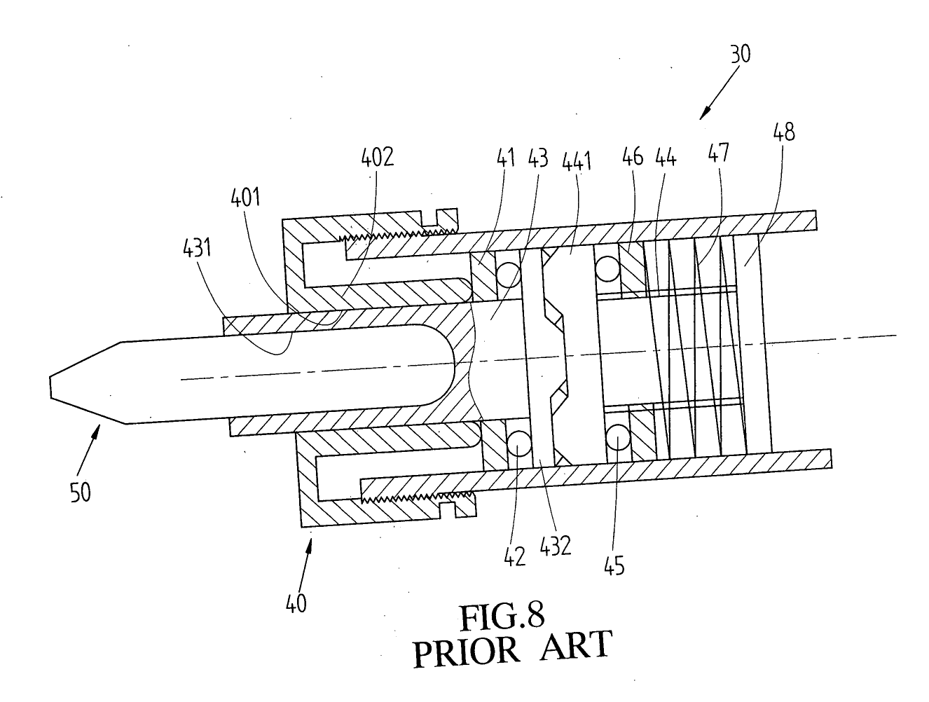

### DETAILED DESCRIPTION OF THE INVENTION

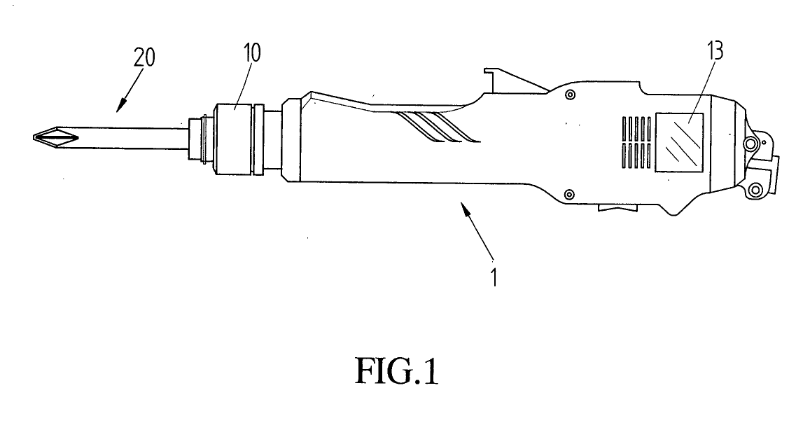

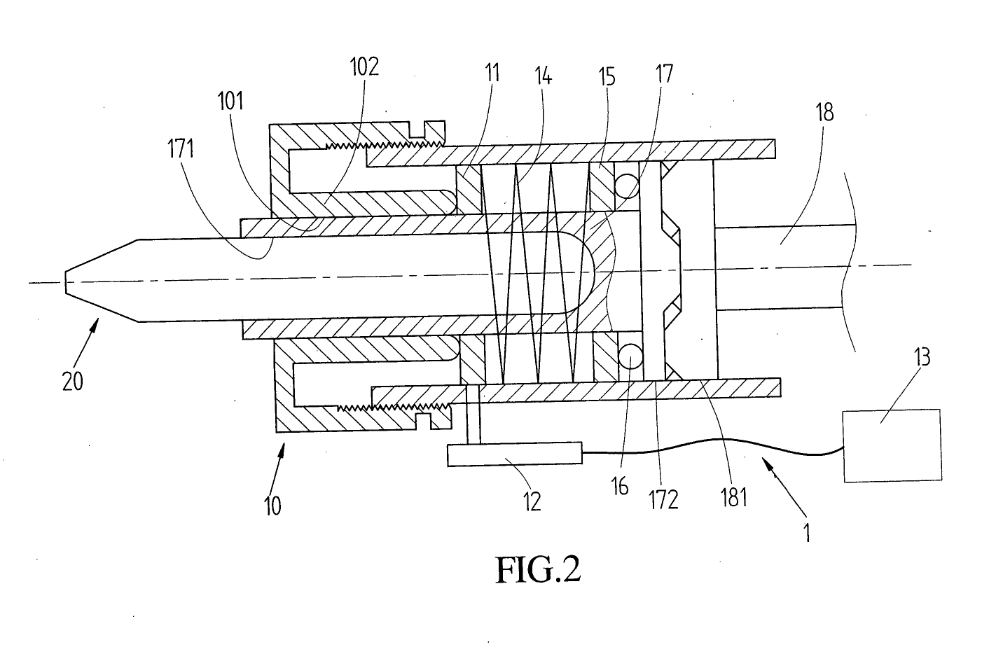

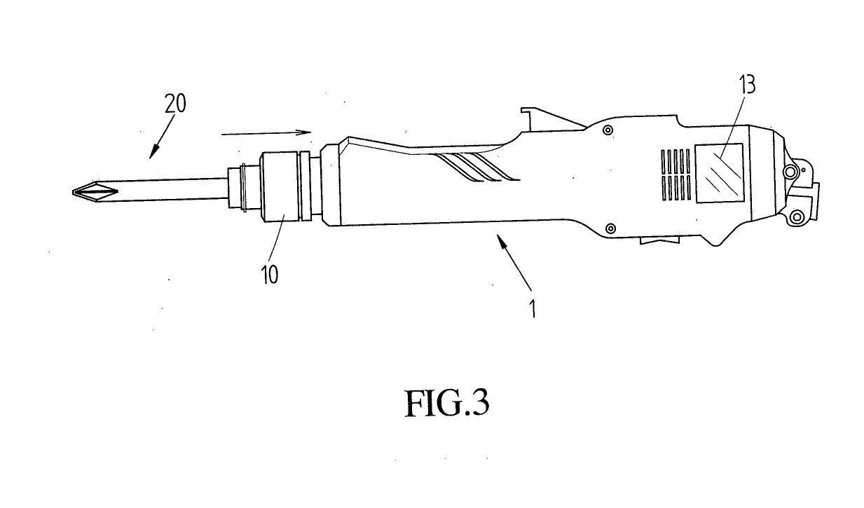

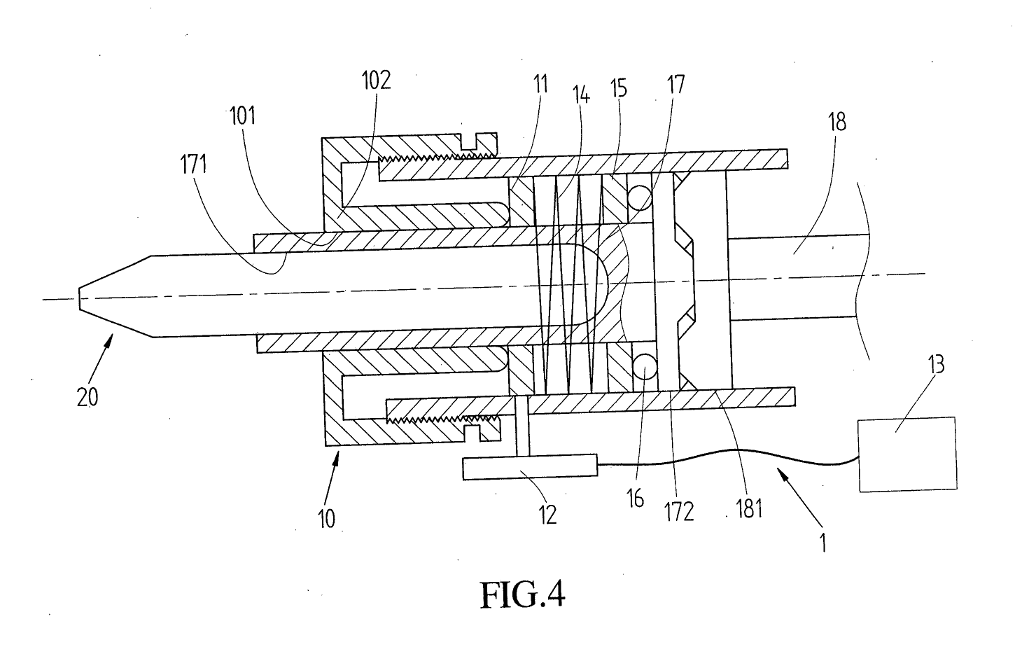

As shown in FIGS. 1 to 4, the present invention is a digital torque control display that has outer screw lines formed on the front end of the gun body 1, and a torque adjuster 10 is placed on it, and the diameter of the torque adjuster 10 has internal screw lines that can be used on the front end of gun body 1; moreover, a through hole 101 is placed in the center of the torque adjuster 10, and a rod 102 is formed on both sides of the through hole 101, and the rod 102 is connected to the first press 11, and one side of the first press 11 is connected to a sensory displacement component 12, and the sensory displacement component 12 is connected to a display 13, and the first press 11 is connected to a spring 14, and the spring is different than one end of the first press 11 that is connected to the second press 15, and the second press 15 is driven by numbers of balls 16 and an output axle, and one end of the output axle 17 goes through the through hole 101, and a connecting hole is placed axially with a tool head 20, and on the other end, on the other end, it has clutch blade 172 and an input axle 18 is placed correspondingly to the output axle 17, and the input axle 18 that is corresponding to the output axle 17 of the clutch blade 172 also form a corresponding clutch blade 181;

among them, the sensory displacement component 12 can be made from all different displacement components such as transformer, capacitive gauge, and linear displacement sensor;

among them, the display is a signal process display, which includes signal processing unit, A-D converter, CPY, display component and display.

Signal processing unit is different according to the displacement component, and different unit transmit the signal to electric signal, then digitalized by A-D converter, and read by CPU, and corrected and converted into different value, and the display component displays the torque value.

The abovementioned combination according to different component includes:

\textcircled{1} Signal process unit and A-D converter in one

\textcircled{2} A-D converter and CPU in one

\textcircled{3} A-D converter, CPU, display component in one

\textcircled{4} CPU and display component in one

\textcircled{5} Display component and display in one

The actual utilization of the present invention is shown in FIGS. 1 to 4, when the torque adjuster 10 is turning, its rod 102 pushes the first press 11, and causes the spring 14 to push against the second press 15, at this time, the second press 15 pushes against the clutch blade 172 of the output axle 17, and creates pressure that is between the clutch blade 172 of the output axle 17, and the clutch blade 181 of the input axle 18 corresponds with the spring pressed by the first press 11, therefore, the torque the clutch can transmit and the pressure of the clutch has certain relationship, and this force is provided by the spring 14, therefore, measuring the pressing value of the spring 14 and convert it to obtain the corresponding torque value; when the pressure of the clutch is bigger, the torque output by the electric gun is bigger as well, therefore, when the torque adjuster 10 makes the first press 11 push against the second press 15, the displacement generated by the first press 12 drives the sensory displacement component 12 and make the sensory displacement component 12 measures the displacement moved by the first press 11 to the display 13, which helps the users understand the torque value output by the electric gun, so that they may adjust the volume of the torque of the tool to prevent the damage of the tool.

The present invention connects to the sensory displacement component 12 at the first press 11, therefore, the displacement can be generated by pushing the rod 102 against the first press, and the measurement may be obtained by the spring to obtain the torque value, and display the torque value by the display 13, and display the value digitally without reading error, and the value of different unit may be switched by keying, and converted by internal CPU without artificial conversion, and the value may be adjusted to the whole number after conversion, which can be used on the torque gun that has different units; in addition, the error generated when making the tool can be obtained by another correcting instrument, then correct it accordingly, which can make the torque value more accurate.

To sum up the abovementioned, the present invention has numbers of effect and practical value, and it can also improve the overall economic effect effectively, therefore, the present invention is indeed a creative work, and there has not been any product that is close or similar to the present invention in the same field, which should meet the requirement of the patent, therefore, the application is submitted for approval.

What is claimed is:

1. A digital torque control display comprising a torque adjuster that can be adjusted on the front end of the gun body, and the torque adjuster has a through hole and a rod that is around the through hole, and the rod is pushed against the first press, and the first press is pushed against the spring, and the other end of the spring that is push against the second press, and the second press presses the output axle by numbers of ball; there is clutch blade that is placed on the interface between the output axle and the input axle; the front end of the output axle goes through the through hole;
the features are: the first press is connected to a sensory displacement component, and the sensory displacement component is connected to a display.

2. The structure defined in claim 1, wherein said tool head is formed on the front end of the output axle.

3. The structure defined in claim 1, wherein said front end of the output axle formed a connecting hold for the placement of the tool head.

4. The structure defined in claim 1, wherein said front end of the gun body has a torque adjuster that can be adjusted and fixed, and the internal screw lines or external screw lines are placed on the front end of the gun body, and the torque adjuster coordinates with the internal or external screw lines.

5. The structure defined in claim 1, wherein said sensory displacement component can be a transformer, capacitive gauge, and linear displacement sensor.

6. The structure defined in claim 1, wherein said display is a signal processing display, which includes signal processing unit, A-D converter, CPU, display component and display;
signal processing unit is different according to the displacement component, and different unit transmit the signal to electric signal, then digitalized by A-D converter, and read by CPU, and corrected and converted into different value, and the display component displays the torque value;
the abovementioned combination according to different component includes
\textcircled{1} signal process unit and A-D converter in one
\textcircled{2} A-D converter and CPU in one
\textcircled{3} A-D converter, CPU, display component in one
\textcircled{4} CPU and display component in one
\textcircled{5} Display component and display in one
